(19) United States
(12) Patent Application Publication
(10) Pub. No.: US 2007/0199317 A1
(43) Pub. Date: Aug. 30, 2007

(54) Arrangement for Recirculation of Exhaust Gases of a Super-Charged Internal Combustion Engine

(76) Inventors: Magnus Pelz, Tullinge (SE); Henrik Skog, Northampton (GB)

Correspondence Address: OSTROLENK FABER GERB & SOFFEN, 1180 AVENUE OF THE AMERICAS, NEW YORK, NY, 100368403, US

(21) Appl. No.: 10/594,645

(22) PCT Filed: Mar. 29, 2005
(86) PCT No.: PCT/SE05/00446

§ 371 Date: Sep. 28, 2006

(30) Foreign Application Priority Data
Mar. 31, 2004 (SE) 0400856-1

(51) Int. Cl. F02B 29/04; F02B 33/44

(52) U.S. Cl. 60/599; 60/605.2; 60/605.1

(57) ABSTRACT

The present invention relates to an arrangement for recirculation of exhaust gases in a supercharged combustion engine. The arrangement comprises an exhaust line intended to lead exhaust gases out from the combustion engine, an inlet line intended to lead air at above atmospheric pressure to the combustion engine, a return line which comprises a connection to the exhaust line and a connection to the inlet line, so that via the return line it is possible to recirculate exhaust gases from the exhaust line to the inlet line. The arrangement comprises a charge cooler which is cooled by ambient air. The charge cooler is incorporated in the inlet line downstream from the connection of the return line to the inlet line so that, when the exhaust gases are returned via the return line, said charge cooler cools a mixture of exhaust gases and air before the mixture is led to the combustion engine.

### BACKGROUND TO THE INVENTION, AND STATE OF THE ART

The present invention relates to an arrangement for recirculation of exhaust gases in a supercharged combustion engine according to the preamble of claim 1.

The technique known as EGR (Exhaust Gas Recirculation) is a known way of leading part of the exhaust gases from a combustion process in a combustion engine back, via a return line, to an inlet line for supply of air to the combustion engine. A mixture of air and exhaust gases is thus supplied via the inlet line to the engine's cylinders in which the combustion takes place. The addition of exhaust gases to the air causes a lower combustion temperature resulting inter alia in a reduced content of nitrogen oxides NOₓ in the exhaust gases. This technique is applied in both Otto engines and diesel engines.

The amount of air which can be supplied to a supercharged combustion engine depends on the pressure of the air but also on the temperature of the air. Supplying the largest possible amount of air to the combustion engine therefore entails cooling the compressed air in a charge air cooler before it is led to the combustion engine. The compressed air is cooled in the charge air cooler by ambient air flowing through the charge air cooler. The compressed air can thus be cooled to a temperature which is only a few degrees higher than the temperature of the surroundings. In cases where EGR technology is used, the returned exhaust gases also need cooling. This is achieved by means of a so-called EGR cooler. An EGR cooler is usually connected to the combustion engine's cooling system so that the exhaust gases are cooled in the EGR cooler by the circulating coolant in the cooling system. The EGR cooler is thus subject to the limitation that the exhaust gases cannot be cooled to a lower temperature than the temperature of the coolant in the cooling system. The cooled exhaust gases are therefore usually at a higher temperature than the cooled compressed air when they are put into the inlet line to the combustion engine. The mixture of exhaust gases and air being led to the combustion engine will therefore be at a higher temperature than the compressed air led into a supercharged combustion engine which is not provided with recirculation of exhaust gases. The performance of a supercharged combustion engine equipped with EGR is therefore somewhat inferior to that of a supercharged combustion engine not equipped with EGR.

### SUMMARY OF THE INVENTION

The object of the invention is to provide an arrangement which effects recirculation of exhaust gases in a supercharged combustion engine in such a way that the recirculation of exhaust gases does not result in the combustion engine's performance being inferior to that of a corresponding combustion engine not provided with recirculation of exhaust gases.

This object is achieved with the arrangement of the kind mentioned in the introduction which is characterised by the features indicated in the characterising part of claim 1. The exhaust gases are thus mixed with the compressed air before they are together cooled in a cooler by a cooling medium which is at a temperature substantially corresponding to the temperature of the surroundings. This means that the mixture of exhaust gases and compressed air being led to the combustion engine is brought to a temperature corresponding to that of the compressed air supplied to a combustion engine not equipped with EGR. The performance of a combustion engine with an arrangement according to the present invention can therefore correspond to that of a combustion engine not equipped with EGR.

According to a preferred embodiment of the present invention, said first medium is ambient air. Ambient air is at all times an available medium and needs no complicated equipment to cause it to flow through the first cooler. Using ambient air as cooling medium makes it possible for the exhaust gases to be cooled down to a level close to the temperature of the ambient air. The same cooling medium is therefore used in the first cooler as in a conventional charge air cooler for cooling of compressed air. This means that exhaust gases can be cooled to the same level as the compressed air in a conventional charge air cooler. The arrangement is used with advantage in a vehicle which is powered by the combustion engine. The result is a natural flow of ambient air through the first cooler during operation of the vehicle. A cooling fan may possibly be incorporated to guarantee the air flow through the first cooler.

According to a preferred embodiment of the present invention, the arrangement comprises a second cooler adapted to cooling the exhaust gases in the return line. A gaseous cooling medium such as air is usually not particularly effective as regards carrying heat away in a cooler. There are substantially more effective coolers than those which are cooled by air. It is therefore advantageous to use such a more effective second cooler for cooling the hot exhaust gases as a first step before they are cooled by the first cooler. Said second cooler is preferably cooled by a liquid medium. A liquid medium usually provides much more effective cooling than a gaseous medium. A liquid-cooled cooler which has the same cooling capacity as an air-cooled cooler can therefore be made considerably smaller. When such a liquid-cooled second cooler is incorporated in the return line, the temperature of the exhaust gases can be lowered in an effective manner as a first step. A significantly lower cooling capacity is therefore required of the first cooler and the latter can therefore be made significantly smaller. The liquid medium may be adapted to circulating in a cooling system which is also adapted to cooling the combustion engine. In such cases the existing coolant in the vehicle's cooling system is thus used for cooling the exhaust gases as a first step. Although the temperature of the coolant will be higher than the temperature of the ambient air, the result is a relatively large difference between the temperature of the coolant and the temperature of the exhaust gases. The coolant in said second cooler can thus provide effective cooling of the exhaust gases.

According to another preferred embodiment of the present invention, said first cooler is situated close to a cooler for cooling the coolant in the cooling system. The first cooler is situated in a region of the vehicle which is already designed to cater for a throughflow of ambient air. In this case a cooling fan may possibly be incorporated with a larger capacity to provide effective cooling both of the coolant in the cooling system and of the mixture of exhaust gases and compressed air in the first cooler.

According to another preferred embodiment of the present invention, the arrangement comprises an EGR valve incorporated in the return line. With such an EGR valve in the return line, the exhaust gas flow can be shut off as necessary. To some extent the EGR valve can also be used for controlling the amount of exhaust gases returned via the return line. A control unit is usually adapted to controlling the EGR valve. The control unit controls the EGR valve on the basis of information about the current operating state of the combustion engine. The control unit may be a computer unit provided with suitable software.

According to another preferred embodiment of the present invention, the arrangement comprises a turbine driven by the exhaust gases in the exhaust line which are not led into the return line, and a compressor driven by said turbine so that it compresses the air in the inlet line. The above atmospheric pressure of the exhaust gases is thus utilised for compressing the air in the inlet line. The combustion engine may be a diesel engine or an Otto engine. In the case of supercharged Otto engines it is relatively easy to add the recirculating exhaust gases to the air, since the exhaust gases in substantially all operating situations will be at a higher pressure than the compressed air in the inlet line. In the case of supercharged diesel engines, the pressure of the exhaust gases in certain operating situations will be lower than that of the compressed air. In such operating situations it is therefore not possible to mix the exhaust gases directly with the air in the inlet line without special auxiliary means. Such auxiliary means is a so-called venturi which may be situated in the inlet line close to the latter's connection to the return line. With such a venturi the static pressure of the air in the inlet line can be reduced locally at the connection to the return line.

### BRIEF DESCRIPTION OF THE DRAWINGS

A preferred embodiment of the invention is described below by way of example with reference to the attached drawing, in which:

FIG. 1 depicts an embodiment of an arrangement for recirculation of exhaust gases in a supercharged diesel engine and

FIG. 2 depicts schematically the positioning of a charge air cooler according to the present invention.

### DETAILED DESCRIPTION OF A PREFERRED EMBODIMENT OF THE INVENTION

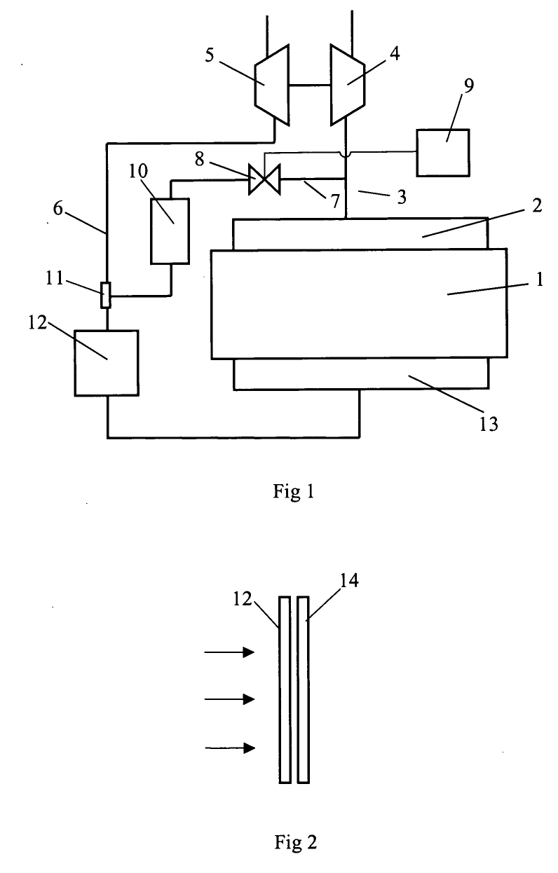

FIG. 1 depicts schematically an arrangement for recirculation of exhaust gases in a supercharged combustion engine. The combustion engine is in this case a diesel engine 1. Such recirculation is usually called EGR (Exhaust Gas Recirculation). Adding exhaust gases to the compressed air which is led to the engine's cylinders lowers the combustion temperature and hence also the content of nitrogen oxides (NOₓ) which are formed during the combustion processes. The diesel engine 1 may for example be intended to power a heavy vehicle. The exhaust gases from the cylinders of the diesel engine 1 are led via an exhaust manifold 2 to an exhaust line 3. The exhaust gases in the exhaust line 3, which are at above atmospheric pressure, are led to a turbine 4. The turbine 4 is thus provided with driving power which is transferred, via a connection, to a compressor 5. The compressor 5 compresses the air which is led into the inlet line 6.

A return line 7 is intended to cater for recirculation of part of the exhaust gases from the exhaust line 3. The return line 7 comprises a valve in the form of an EGR valve 8 by which the exhaust gas flow in the return line 7 can be shut off as necessary. The EGR valve 8 can be used for controlling the amount of exhaust gases led via the return line 7 to the inlet line 6. A control unit 9 is adapted to controlling the EGR valve 8. The control unit 9 controls the EGR valve 8 on the basis of information about the current operating state of the diesel engine. The return line 7 also comprises an EGR cooler 10 for cooling the recirculating exhaust gases before they are mixed with the compressed air in the inlet line 6. The amount of air and exhaust gases which can be supplied to the diesel engine 1 depends on the pressure of the air and the exhaust gases, but also on the latter's temperature. It is therefore important to provide effective cooling of the recirculating exhaust gases. The exhaust gases which are circulated through the EGR cooler 10 are cooled by the coolant in the vehicle's existing cooling system, which is also intended to cool the diesel engine 1. In the case of supercharged diesel engines 1, the pressure of the exhaust gases will in many cases be lower than the pressure of the compressed air in the inlet line. In such operating situations it is not possible to mix the returned exhaust gases from the diesel engine 1 directly with the compressed air in the inlet line 6 without auxiliary means. To this end it is possible to use, for example, a venturi 11. If the combustion engine is instead a supercharged Otto engine, the exhaust gases can be led directly into the inlet line 6, since the exhaust gases of an Otto engine in substantially all operating situations will be at a higher pressure than the compressed air in the inlet line 6.

A charge cooler 12 is arranged in the inlet line 6. The charge cooler 12 is cooled by ambient air. The compressed air and the exhaust gases mixed in the inlet line 6 are intended to be led together through the charge cooler 12 in order to be cooled. FIG. 2 depicts schematically a view from above of the charge cooler 12. In this case it is situated close to a conventional cooler 14 for cooling the coolant in the vehicle's cooling system. The charge cooler 12 and the cooler 14 are arranged substantially in parallel at a distance from one another. The exhaust gases and the compressed air in the charge cooler 12 and the coolant in the cooler 14 are cooled in this case by ambient air which flows first through the charge cooler 12 before flowing through the cooler 14. When the mixture of exhaust gases and compressed air has been cooled in the charge cooler 12, it is led via a manifold 13 to the respective cylinders of the diesel engine 1.

During operation of the diesel engine 1, the exhaust gases drive the turbine 4. The turbine 4 is thus provided with driving power which drives a compressor 5. The compressor 5 compresses the air which is led into the inlet line 6. In most operating states of the diesel engine 1 the control unit 9 keeps the EGR valve 8 open so that part of the exhaust gases in the exhaust line 3 is led into the return line 7. In this situation the exhaust gases are at a temperature of about 600-700° C. When the exhaust gases in the return line 7 reach the EGR cooler 10 they undergo a first step of cooling. At this stage the exhaust gases are cooled by the coolant in the cooling system. The exhaust gases can thus be cooled effectively so that they are at a considerably reduced temperature when they leave the EGR cooler 10. The EGR cooler 10 is subject, however, to the limitation that it can at best cool the exhaust gases to a temperature corresponding to the temperature of the coolant. The temperature of the coolant in the cooling system may vary but in normal operation is usually within the range 80-100° C.

In supercharged diesel engines 1 in certain operating situations the pressure of the exhaust gases will thus be lower than the pressure of the compressed air in the inlet line 6. The venturi 11 can be used to reduce the static pressure of the air in the inlet line 6 locally, close to the return line 7, so that the exhaust gases can be led into and mixed with the compressed air in the inlet line 6. The mixture of exhaust gases and compressed air is led thereafter together through the charge cooler 12. The mixture of exhaust gases and compressed air is cooled together in the charge cooler 12 by the ambient air which flows through the charge cooler 12. The size of the charge air cooler 12 is with advantage such that the mixture of exhaust gases and compressed air is cooled down to a temperature which only exceeds the temperature of the surroundings by a few degrees. After the charge cooler 12, the mixture is led to the respective cylinders of the diesel engine 1. In contrast to conventional EGR technology, the exhaust gases in this case are also subjected to a second step of cooling. The exhaust gases are thus mixed with the compressed air before they are together cooled in the charge cooler 12 by ambient air as cooling medium. The mixture of exhaust gases and compressed air being led to the diesel engine 1 can therefore be brought to a temperature corresponding to that of the compressed air which is supplied to a corresponding diesel engine not equipped with EGR. The performance of a diesel engine with such cooling of the recirculating exhaust gases can thus substantially correspond to that of a combustion engine not equipped with EGR.

The invention is in no way limited to the embodiment described in the drawing but may be varied freely within the scopes of the claims. The possibility is thus not excluded of the recirculating exhaust gases being led directly into the inlet line without cooling and of the whole cooling of the exhaust gases together with the compressed air taking place in a charge cooler.

1. An arrangement for recirculation of exhaust gases in a supercharged combustion engine, the arrangement comprising:
an exhaust line operable to lead exhaust gases out from the combustion engine; an inlet line operable to lead air at above atmospheric pressure to the combustion engine,
a return line comprising a connection to the exhaust line and a connection to the inlet line, so that the return line is operable to recirculate exhaust gases from the exhaust line to the inlet line; and
a second cooler operable to cool the exhaust gases in the return line by use of a liquid medium,
a first cooler cooled by ambient air, the first cooler is incorporated in the inlet line downstream from the connection of the return line to the inlet line so that, when the exhaust gases are returned via the return line, the first cooler cools a mixture of exhaust gases and air before the mixture is led to the combustion engine.

2. An arrangement according to claim 1, further comprising a cooling system containing a liquid medium and which is operable for cooling the combustion engine.

3. An arrangement according to claim 2, further comprising a cooler arranged close to the first cooler for cooling the coolant in the cooling system.

4. An arrangement according to claim 2, further comprising an EGR valve incorporated in the return line.

5. An arrangement according to claim 4, further comprising a control unit operable for controlling the EGR valve.

6. An arrangement according to claim 2, further comprising a turbine positioned, and operable for being driven by the exhaust gases in the exhaust line which are not led into the return line, and a compressor operable to be driven by the turbine so that the compressor compresses the air in the inlet line.

7. An arrangement according to claim 1, further comprising the combustion engine is a diesel engine or an Otto engine.

8. An arrangement according to claim 7, further comprising a venturi between the return line and the inlet line, wherein the venturi delivers returned exhaust gases drawn into the inlet line.

9. An arrangement according to claim 1, further comprising an EGR valve incorporated in the return line.

10. An arrangement according to claim 2, further comprising a turbine positioned, and operable for being driven by the exhaust gases in the exhaust line which are not led into the return line, and a compressor operable to be driven by the turbine so that it compresses the air in the inlet line.
